(19) United States
(12) Patent Application Publication
(10) Pub. No.: US 2007/0229222 A1
(43) Pub. Date: Oct. 4, 2007

(54) SYSTEM AND METHOD FOR PRESENTING CUSTOMIZED SELECTIONS OVER A COMPUTER NETWORK

(76) Inventor: Richard A. Leeds, Seattle, WA (US)

Correspondence Address: DAVIS WRIGHT TREMAINE, LLP, 1201 Third Avenue, Suite 2200, SEATTLE, WA, 98101-3045, US

(21) Appl. No.: 11/757,895

(22) Filed: Jun. 4, 2007

Related U.S. Application Data
(63) Continuation of application No. 09/510,580, filed on Feb. 22, 2000.

(51) Int. Cl. G06F 7/00

(52) U.S. Cl. 340/5.91

(57) ABSTRACT

A system for presenting tailored store screens including customized selection screens for merchandise and/or services over a computer network utilizes a host computer communicatively linked to one or more remote computers used by shoppers. The host computer includes a shopper data collector, a shopper database, a store database, a merchandise database, a services database, a presentation formulator, and a web server optionally serving many store sites with overlapping product lines. As one of the remote computers is in current communication with the host computer, the customer data collector collects and analyzes data from the remote computer including search requests, uniform resource locators (URLs), and hidden data. The shopper is generally unaware that the hidden data is being collected by the shopper data collector and includes cookie data stored on the remote computer of previous shopping events such as previous purchases, search requests, and URLs previously visited. Information based upon the data collected by the shopper data collector is stored in the shopper database for subsequent use and is also sent to the presentation formulator. The presentation formulator formulates tailored store screens including customized selection screens for merchandise and/or services based upon data collected in the current communication and stored in the shopper, store, merchandise, and services databases.

### CROSS REFERENCE TO RELATED APPLICATION

This application is a continuation application of U.S. Ser. No. 09/510,580 filed Feb. 22, 2000.

### TECHNICAL FIELD

The invention is related generally to selling merchandise using electronic commerce and, more particularly, to systems for presenting information, including advertisements, to shoppers.

### BACKGROUND OF THE INVENTION

Today's physical world of “brick and mortar stores” contains a large selection of retail and wholesale businesses where shoppers can view a selection of merchandise and/or services, solicit help for determining information about the merchandise, and weigh a decision of whether to purchase a particular merchandise item or service. Wholesalers establish strong business relationships and have excellent communication with their shoppers in order to develop long-standing channels for merchandise distribution. Retailers try to select popular merchandise that a large percentage of shoppers wish to purchase. Additionally, a retailer will often offer several selections in a particular merchandise category that each extol a different set of characteristics. For instance, one merchandise may have a low price, but is scant on features. Another merchandise may be feature laden, but come from a manufacturer that fails to command a large market presence, or be known at all. Quality is another feature that is difficult to ascertain until the purchase is already complete and its performance later judged.

Purchasers of merchandise tend to make buying decisions based on certain factors. Some of these factors include: price of the merchandise, brand name production or association with the merchandise, features of the merchandise, and location of the store selling the merchandise, as well as other factors.

Merchandise retailers also strengthen their sales by encouraging a human habit of impulse buying. An impulse buy is one where the purchaser did not intend to buy the merchandise when they entered the store, but ultimately purchased the merchandise anyway. Oftentimes impulse items will be conveniently located near main aisles, or near checkout counters. A location that is also used for high-exposure promotions or impulse items is an “end-cap,” which is the area at the end of an aisle. Endcaps of secondary aisles are what shoppers primarily see when they walk down the main aisles in a store. Retailers often put the most frequently desired merchandise near the rear of a store, so that shoppers must pass most or all of the store's endcap promotions. Grocery stores routinely place their dairy department in one rear corner of the store and their bakery in the other rear corner. This causes many shoppers who want to purchase bread and milk to pass by most of the endcap promotions of the store.

An additional concept getting more attention by retailers is cross-category merchandising. This concept includes physically grouping together items typically not located in close proximity to one anther, so that a purchase of one item may spur the shopper to purchase at least one of the other items. For example, a cross-category display may be erected that includes sunglasses, folding chairs, sun-tan lotion, a child's spade and bucket, a portable fan, and a waterproof disposable camera. Although these merchandise are separately shelved in other disparate areas of the store, placing them together allows the shopper who is planning a day at the beach to purchase several associated items without locating each of the merchandise separately. Thus, related merchandise sales increase. Combining cross-category merchandising with the above-described endcap promotion leads to even more sales for the store.

Despite the research and development poured into retail buying habits, and despite the gains made by endcap promotions and cross-category merchandising, no promotion is successful for every shopper. Because shoppers'preferences vary, it is impossible to develop a promotion that appeals to all shoppers. Because retail space is limited, and relatively expensive, developing multiple, slightly different promotions in an effort to appeal to a broader shopper base is prohibitively expensive.

Computer-based shopping is also growing in popularity. Although powerful computer search engines such as Alta-Vista or Lycos can search the world wide web for particular merchandise, the shopper must key-in very specific information about a merchandise prior to searching, such as the exact model name or number, otherwise the shopper runs the risk of being inundated by thousands or hundreds of thousands of search results. Requiring the shopper to know specific and detailed information about the merchandise runs counter to a merchant's desire to introduce new merchandise. Searching on a generic or non-specific search term, however, produces the overwhelming number of results described above, which has little utility for the shopper.

### SUMMARY OF THE INVENTION

The present invention resides in a system and method for presenting customized selections over a computer network.

Aspects of the system and method include collecting from a shopper's remote computer first data either being hidden data that is hidden from the shopper or data related to a purchase by the shopper during a past shopping communication between the shopper's remote computer and a host computer communicatively linked to the shopper's remote computer. Further aspects include storing the first data and collecting a second data from the shopper's remote computer during a current shopping communication between the shopper's remote computer and the host computer. Additional aspects include retrieving the first data from storage based at least in part upon the second data, formulating tailored store screens based at least in part on the first and second data, and sending the tailored store screens to the shopper's remote computer for display.

### BRIEF DESCRIPTION OF THE DRAWINGS

FIG. 1 is a functional drawing representing an electronic commerce store system according to an embodiment of the invention.

FIGS. 2 and 3 are layout diagrams of exemplary tailored store screens according to the depicted embodiment.

### DETAILED DESCRIPTION OF THE INVENTION

In brick-and-mortar retailing, approximately 70% of purchase decisions by shoppers while they are in a story by seeing and purchasing items on impulse as they walk the aisles. The term “shopper” includes individuals who are shopping for the first time with a particular store or other business as well as customers who are shopping again after previous acquisitions. Retailers try to leverage impulse buying by promoting special merchandise in displays at the end of the aisles, known as “end caps.” In addition, innovative retailers are experimenting successfully with cross-category product promotions merchandising together products normally found in different store departments to increase sales of both.

The concepts of impulse buying and cross-category merchandising are largely absent in electronic retailing dissociated with electronic commerce (e-commerce). No company is known to harness the flexibility and power of web technology to create an intuitive, dynamic shopping environment customized for each individual shopper. Embodiments of the present invention are directed toward capitalizing on this opportunity.

Embodiments of the present invention provide custom selections for each shopper interaction and the cross-category promotion of related products to shoppers. Merchandise and/or services being displayed and promoted are dynamically assembled into an individual environment from a large array of merchandise and/or services based on information derived from a shopper's entry point into a network, such as a store network, and from prior shopper selections, purchases and other supplied information. Possible “entry point information” includes domain names of a store network, search key words, Domain Naming System (DNS) entries, and operating systems for computers used by shoppers. For example, the same shopper accessing an e-commerce store through different domain names such as skispecialties.com, skidiscountstore.com, or skispecialist.com may receive different displayed information. The same shopper, for example, searching for “cheap skis” vs. “Rossignol” vs. “shaped skis” vs. “Seattle ski shop” may receive different displayed information. A shopper using a computer with a Domain Naming System (DNS) entry in New York vs. Washington vs. Colorado entering the same domain name to access may also receive different displayed information. Shoppers using computers running Windows 3.1 vs. Windows 95 vs. Windows 98 vs. Windows 2000 beta, etc., may also receive different display information.

Embodiments of the present invention may be applied to sell an extremely wide range of products from a vast number of different categories. Products can be dynamically aggregated for hundreds of e-commerce stores, each with their own domain name resource or Universal Resource Locator (URL) or other network address. Products can be associated with more than one e-commerce store, and shoppers can browse e-commerce stores through pre-defined e-commerce store names (domain names such as bookdiscountstore.com) or search for specific products or specialties.

As a shopper moves through the shop-and-search process, some embodiments of the present invention can assemble a customized e-commerce store for that specific shopper based on their buying habits, previous purchases, etc. Customized e-commerce stores are made up of category specific items and cross category items related to the item being considered by the shopper. Moreover, the e-commerce store changes as the shopper's shop-and-search process evolves during the specific shopping visit.

An example of an eStore embodiment of the present invention is as follows. Tom X. is shopping for barbecue grills. He seeks access to shop through the eStore embodiment using a domain name such as “eStoreNet.com” and does a search for grills using a search engine provided through the web site associated with “eStoreNet.com”. A customized e-commerce store is assembled based on Tom's interests and past purchase behavior, the store displays quality branded grills and also prompts Tom to consider related branded items such as The Art of the Grill cookbook by Kelly McCune, Smoky Joe's Original Barbecue Sauce, and beef ribs from Omaha Steaks. While there are many barbecue grills and products related to barbecue grills in the product matrix of the eStore embodiment, specific items are selected and recommended to Tom based on factors including his prior shopping behavior, tastes and interests.

As another example, instead of accessing the eStore embodiment by the “eStoreNet.com” domain name, Fred Y. enters the site through a “HardwareDiscountStore.com” domain name to look for his grill. Fred rarely shops for name brands and usually picks the lowest priced item. A customized e-commerce store is assembled for Fred displaying prompts, advertisements, or other information for low-priced grills and also grill covers, grilling utensils and the like. As noted, each of these shoppers are presented with displays of customized e-commerce stores including different options and promotions.

Both shoppers and the manufacturers, retailers, distributors, and other vendors using embodiments of the present invention may gain benefits. Shoppers benefit because of a much richer Internet shopping experience compared with conventional e-commerce systems and methods. The spontaneity of traditional non-e-commerce shopping is maintained and shoppers are exposed to a wider array of products. Moreover, the product set offered to the shopper reflects their tastes and interests and are continuously refined over time as they shop more frequently using embodiments of the present invention and more information about their shopping habits and preferences are collected.

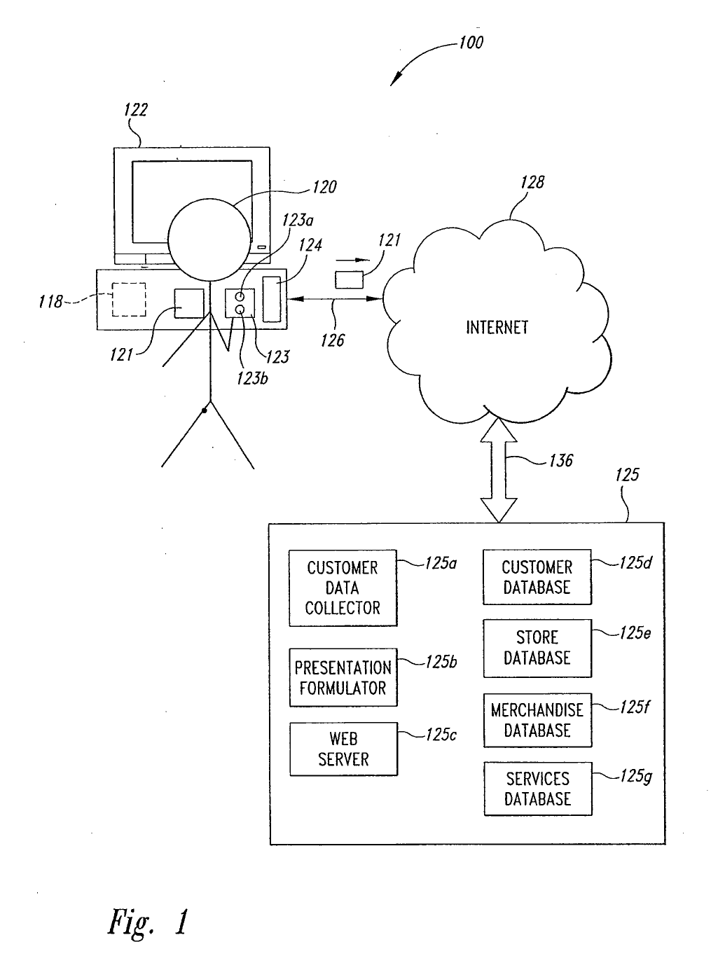

An electronic commerce (e-commerce) store system 100 is represented in FIG. 1 for creating tailored e-commerce store screens for display on shopper computers including one or more customized merchandise and/or service selection screens that are unique for an individual shopper 120. The e-commerce store system 100 is directed toward the shopper 120 who types commands and data 121 into a remote computer 122 that includes a storage 123 that stores processes and data such as a cookie 123a with cookie data 123b. The commands and data 121 are then sent by the remote computer 122 to a host system 125 by way of a communication network such as the Internet 128.

For the depicted embodiment, the host system 125 includes a shopper data collector 125a, a presentation formulator 125b, a web server 125c, a shopper database 125d, a store database 125e, a merchandise database 125f, and a services database 125g. The shopper data collector 125a analyzes the commands and data 121 received from the remote computer 122 and the cookie data 123b stored on the remote computer to identify information pertinent to the shopper 120 to be used for real time processing by the presentation formulator 125b and for subsequent storage of the pertinent shopper information in the shopper database 125d.

Based upon the pertinent shopper information identified in real time by the shopper data collector 125a and other pertinent shopper information previously stored in the shopper database 125d, the presentation formulator 125b will retrieve data customized for the shopper from the store database 125e, the merchandise database 125f, and the services database 125g with details regarding overall store, merchandise, and services information that are directed toward the particular shopper 120. The presentation formulator 125b then uses this customized data to formulate one or more screens custom tailored to the shopper 120 for display on the remote computer 122. These tailored store screens include customized selection screens for merchandise and/or services. Because the tailored store screens including the customized selection screens are configured with as much specificity to the shopper 120 as possible, the shopper is more likely to conduct business through the use of the e-commerce store system 100.

The amount of pertinent shopper information used by the host system 125 will vary depending on the particular shopper 120. If the shopper 120 has previously contacted the host system 125, they may have completed a shopper preferences survey or other type of survey. Through a survey, the shopper 120 could identify which criteria, such as price, brand name, merchandise details, etc. that the presentation formulator 125b should factor into the tailored store screens. Survey results are tabulated and stored in the shopper database 125d of the host system 125 for subsequent use by the presentation formulator 125b. For instance, if the shopper 120 has previously indicated to the host system 125 that brand name recognition of a merchandise is of highest importance, the presentation formulator 125b will, to the extent possible, prevent any generic-branded or non-branded merchandise from being listed on the shopper's customized selection screens and emphasize such things as merchandise logos and trademarks in the tailored store screens. In another example, if the shopper 120 has previously indicated to the host system 125 that endorsements from magazines and price are of highest importance, then the presentation formulator 125b would formulate the tailored store screens with price and endorsement information prominently displayed. In a third example, if the shopper has previously indicated to the host system 125 that French wine and European travel were of high importance then the presentation formulator 125b would formulate the tailored store screens to emphasize such things as tours of France, tours of wineries, and books regarding wine including in particular wine from France.

The host system 125 is not, however, limited to providing tailored store screens only to those shoppers 120 who have submitted the shopper survey to the host system. Instead, the host system 125 can provide tailored store screens for any shopper 120, based on a variety of factors and data. For instance, the pertinent shopper information used by the presentation formulator 125b may be directly provided by the shopper 120 to the shopper data collector 125a of the host system 125, such as a formulated search request, or a particular universal resource locator (URL) or other type of network address that the shopper entered to navigate to the host system. Once the remote computer 122 initially accesses the host system 125, the shopper 120 will furnish additional URLs to the remote computer to navigate various tailored store screens of web pages provided by the web server 125c of the host system. These additional URLs used to navigate within the tailored store screen web pages provided to the shopper 120 by the host system 125 can also be recorded and analyzed by the shopper data collector 125a for storage in the shopper database 125d and for use by the presentation formulator 125b. Thoughtful design of the individual web pages containing the tailored store screens and arrangement of the web pages relative to one another can enhance the quality of pertinent shopper information related to internal navigation by the shopper 120 within the e-commerce store system 100 that can be gathered by the shopper data collector 125a.

A search request formulated by the shopper 120 or a list of one or more URLs used by the shopper to navigate to the host computer 125 may be used by the shopper data collector 125a to determine particular traits, habits, or interests of the shopper or other pertinent shopper information for use by the presentation formulator 125b and storage in the shopper database 125d. For instance, many consumers make purchases based on cost, specification details, or brand loyalty. These and other considerations may be evident in search terms or URLs used to access the host computer 125.

A collection of domain names can be particularly useful in determining various traits, habits, and interests of the shopper 120. For exemplary purposes, the following case involves the shopper 120 conducting an Internet search associated with a wine purchase. In this example, after conducting a preliminary search with an Internet search engine using keywords including “wine”, the shopper is presented by the search engine with the following list of domain names being a portion of domain names available from the host system 125 for review: “californiawines.com”, “redwines.com”, “cheapwines.com”, “gourmetwines.com”, “genericwines.com”, “bargainwines.com”, “brandnamewines.com”, “popularwines.com”, “rarewines.com”, and “frenchwines.com”.

For this wine selection example of the depicted embodiment of the e-commerce store system 100, the listed wine domain names could be so owned and the web server 125c could be so configured that all of the listed wine domain name are used to access wine merchandise data on the merchandise database 125f of the host system 125 from the remote computer 122. Even though every domain name on the wine list above could be used to access wine data on the merchandise database 125f, differently selected wine data will be presented in a different manner by the web server 125c to the remote computer 122 as instructed by the presentation formulator 125b depending upon the particular domain name used to access the host system 125.

If the shopper 120 places cost as the highest priority in determining a wine selection, the shopper would most likely select the domain names “cheapwines.com”, “bargainwines.com”, or “genericwines.com” from the above list of domain names for review of associated web pages. If “cheapwines.com” was selected by the shopper 120, the shopper data collector 125a would supply this domain name information to the shopper database 125d for storage and to the presentation formulator 125b.

Based upon pertinent shopper information already in the shopper database 125d and the pertinent shopper information provided by the shopper data collector 125a regarding use by the shopper 120 of the “cheapwines.com” domain name to access the host system 125, the presentation formulator 125b would formulate one or more tailored store screens including one or more customized selection screens directed to a merchandise set that emphasizes inexpensive wines with less emphasis on such characteristics as brand, quality, age, or location. In the depicted embodiment, the “look and feel” of the tailored store screens, including layout, patterns, colors, icons, symbols, pictures, shapes, positioning, etc., would also emphasize aspects based upon the pertinent information on the shopper 120 such as thriftiness.

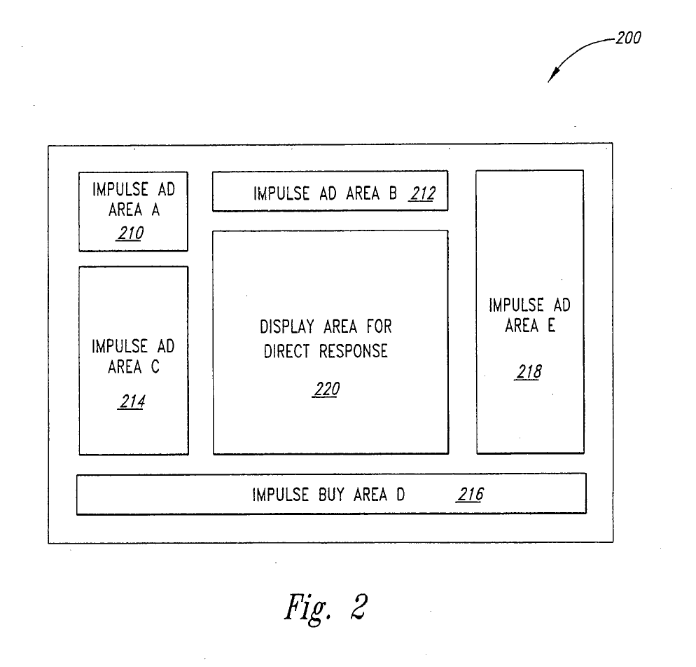

In the depicted embodiment for this wine selection example, additional aspects of the tailored store screens would be directed to impulse buying habits of the shopper 120 regarding merchandise and/or services other than inexpensive wines. For instance, an area of one of the tailored store screens could advertise one or more books on making wine inexpensively. Other areas of the tailored store screens could advertise inexpensive party items such as snacks and glassware. Another area of the tailored store screens could display information about merchandise related to other than wine such as bargain deals on camping gear, sports equipment, candy, or stereo equipment based upon other pertinent information about the shopper 120. The amount of area of the one or more tailored store screens devoted to impulse purchases versus planned purchases would vary. An example of a tailored store screen 200 is shown in FIG. 2. The tailored store screen 200 includes impulse advertisement areas 210-218 dedicated to display of information designed to encourage impulse purchases by the shopper 120. In the example of FIG. 2, the impulse advertisement areas 210-218 are of various sizes. The impulse advertisement areas 210-218 surround a direct response advertisement area 220, which is dedicated to display of merchandise and/or services requested by the shopper 120 based upon a planned purchase decision.

In the depicted embodiment, the various areas of the tailored store screen 200 of FIG. 2 contain information on merchandise and/or services such as advertisements and/or selection lists that are tailored to the shopper 120. For instance, if the shopper 120 was shopping for a printer, the information displayed in the various areas of the store screen 200 would vary depending upon individual priorities valued by the shopper, including whether the shopper was interested in particular specification details associated with the printer, such as the printer having a 16 pages per minute or greater print speed capability, whether the price of the printer was below a certain threshold, such as below $500, or whether the printer was made by a particular manufacturer, such as Hewlett Packard.

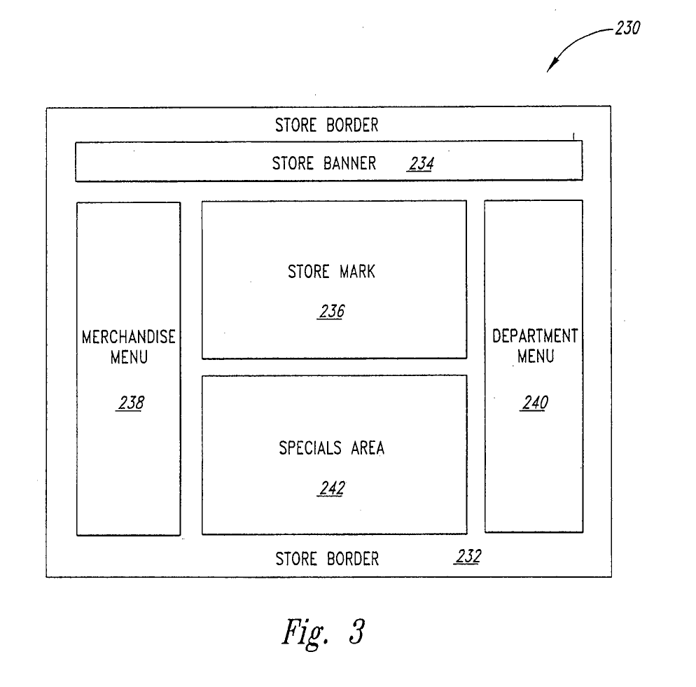

Another example is a tailored store screen 230 shown in FIG. 3 where areas of the tailored store screen 230 include a store border 232, a store banner 234, a store mark 236, a merchandise menu 238, a department menu 240, and a specials area 242. The store border 232, the store banner 234, and the store mark 236 can be tailored to distinguish a first set of one or more web pages having different domain name addresses from a second set of one or more web pages having other domain name addresses even though both sets of one or more web pages provide access to information contained in the merchandise database 125f and the services database 125g. An example of this involves a series of domain names for a plurality of e-commerce university bookstores such as UWstore.com, Harvardstore.com, CUstore.com, Yalestore.com, and UTstore.com. Each domain name would access a set of web pages that have the store border 232 in the school colors, the store banner 234 including the name of the school, and the store mark 236 including a logo of the school and a photo of a prominent landmark found on the school campus. In the depicted embodiment, the merchandise menu 238, the department menu 240, and the specials area 242 are tailored to the individual shopper 120 and may include emphasis on cost, brand, and/or specification detail, but would also include emphasis on the particular school associated with the domain name used by the shopper for access. In an alternative embodiment, the merchandise menu 238, the department menu 240, and the specials area 242 may only be tailored to the school associated with the particular domain name initially used by the shopper 120 for access.

The merchandise menu 238 could include items more directed to the shopper's stated interests such as found in search terms as collected by the shopper data collector 125a. The department menu 240 and the specials area 242 could be more directed to emphasize impulse transactions only tangentially related to the shopper's interests as explicitly stated. The specials area 242 could also include an advertising area for business concerns that have sub-contracted with the e-commerce university bookstore for impulse advertising to particular demographically defined shoppers. There are numerous examples of how the tailored store screens are configured for the particular domain name used for access and/or for the particular shopper 120 involved. Examples include configuration of text content and text style, background and foreground design, graphics and photographs used, and screen layout.

Hidden data that is stored on or generated by the remote computer 122 may be gathered by the shopper data collector 125a of the host system 125 without the shopper's knowledge that such data is being collected. Examples of such hidden data include the cookie data 123b on the remote computer 122 or data stored in other files on the storage 123 of the remote computer 122. Cookies were originally designed to permit servers to save information on a client computer between invocations of a web browser. Cookies are now of more general use so that cookie data, either on the storage 123 and/or the host system 125, may contain a wealth of information about a user's habits and interests including particular websites frequented by the shopper 120. Pertinent shopper information found in this hidden data can also be used by the presentation formulator 125b and web server 125c in generating tailored store screens. Another use of the cookie data by the invention involves the shopper 120 who has previously logged off the e-commerce store system 100 before completing purchases of items found in an e-commerce shopping cart. An e-commerce shopping cart is generally known in the art as a real-time list of items selected by the shopper 120 during the shopping selection process for purchase upon completion of the selection process by the shopper. In the depicted embodiment, a cookie stored on the remote computer 122 used by the shopper 120 retains data associated with the contents of the shopping cart so that the e-commerce store system 100 will provide the shopper with another shopping cart containing the same items of the shopper's cart before the shopper logged off.

Although the host system 125 including the shopper data collector 125a, the presentation formulator 125b, and the shopper database 125d are directed toward individual shoppers in the depicted embodiment, alternative embodiments collect and store data and formulate presentation according to various groups of shoppers as well as individual data on the particular shopper 120. For instance, in some embodiments, shopper data is stored according to various shopper group classifications along with individual shopper data. In some of these alternative embodiments, the presentation formulation 125b will then formulate presentations based upon particular group classifications that a shopper falls under as well as the identity of a particular shopper.

Hidden data may include past buying history (i.e., merchandise previously purchased), past searching history (i.e., search terms previously used) or a combination of both of these (i.e., did any prior search result directly lead to a purchase). Still other pertinent shopper information can be collected by the shopper data collector 125a when the shopper 120 connects to the host system by using specific computer programs, as discussed in detail below.

Referring back to FIG. 1, the functional components of the e-commerce store system 100 used to create the tailored store screens for the shopper 120 will be discussed. The remote computer 122 is communicatively linked to the Internet 128 or other suitable data communication network by a communication connection 126, such as a phone line, a cable television line, or even a satellite link. This communication connection 126 couples to a modem 124 housed within or communicatively linked to the remote computer 122. The modem 124 is used to send data and commands 121 over the communication connection 126 to the Internet 128. Of course, the modem 124 and communication connection 126 must operate with one another, and any communication connection 126 and modem 124 combination that enables the remote computer to transfer data and commands to the Internet 128 is acceptable.

Components of the host system 125 are also connected to the Internet 128 by a second communication connection 136. As described above, the specific implementation of the communication connection 136 is not important, so long as data and commands can be received from and sent to the Internet 128, by the host system 125.

The host system 125 contains several functional components shown in FIG. 1. These components can be physically implemented in a variety of ways, for instance they can be processes and hardware contained in one host computer (not shown), or each of them can be separate processes running on separate computers (not shown). Similarly, they can all be standalone devices. The method of implementing the host site is of little importance, if the functionality described herein is performed. In the depicted embodiment, some of the functional components of the host system 125 are implemented with Unix Solaris by SUN, Microsoft NT 4.0, Oracle 8.0, SQL language, and Visual Basic; however, other embodiments use various other processes and devices to implement the functional components.

A particular example of collecting pertinent shopper information from hidden data found on the remote computer 122 involves the shopper data collector 125a receiving information about a current communication session from the remote computer 122. For instance, in the depicted embodiment, the remote computer 122 runs a World Wide Web browser 148, known as a web client, such as Netscape Navigator or Microsoft's Internet Explorer. The web browser 148 sends data to the web server 125c, which is a computer program or set of programs running on the host system 125. The web server 125c and web browser 148 interact with one another and send data and commands for one another using the Hypertext Transport Protocol (HTTP).

HTTP includes provisions for sending “header fields” from the web browser 148. These header fields are read by the shopper data collector 125a. The header fields contain information that may be used by the host system 125 to determine pertinent information about the shopper 120. This information can then, in turn, be used to formulate the one or more tailored store screens including the one or more customized selection screens. For instance, a common header field is “User-Agent,” which tells the type of the web browser 148 is running on the remote computer 122. Oftentimes, the web browser 148 will also indicate the type of operating system the remote computer 122 is running. For instance, an example of a set of header fields sent by the web browser 148 to the web server 125c on the host system 125 is shown in Table 1.

TABLE 1

Accept: image/gif, image/x-xbitmap, image/jpeg, image/pjpeg,
application/msword, */*
Accept-Language: en-us
If-Modified-Since: Wed, 30 Jun 1999 00:29:04 GMT; length=349
User-Agent: Mozilla/4.0 (compatible; MSIE 4.01; Windows NT)
Host: www.w3.org
Proxy-Connection: Keep-Alive

The “MSIE 4.01” entry in the User-Agent field in Table 1 tells the shopper data collector 125a that the shopper 120 is running Microsoft's Internet Explorer version 4.01. The “Mozilla/4.0 compatible” entry tells the shopper data collector 125a that the remote computer 122 can accept information sent formatted for Netscape Navigator 4.0 (Mozilla was the working name for the first version of Netscape Navigator and, for historical reasons, is still referred to in computer circles as Mozilla). Additionally, the “Windows NT” entry in the same field shows that the shopper 120 is running the Microsoft Windows NT operating system. Thus, even though the shopper 120 doesn't realize it, the host system 125 collects distinguishing data about the shopper.

All distinguishing data, whether or not the shopper 120 knows it is being sent to the host system 125, is received by the shopper data collector 125a. The shopper data collector 125a is communicatively linked to the shopper database 125d. The shopper database 125d can utilize any device capable of storing the data supplied to it by the shopper data collector 125a, such as a hard disk drive, an optical drive, a CD-ROM or DVD-ROM drive, or the like. The data stored in the shopper database 125d may be indexed to an individual, or a group of individual shoppers 120.

From the foregoing it will be appreciated that, although specific embodiments of the invention have been described herein for purposes of illustration, various modifications may be made without deviating from the spirit and scope of the invention. Accordingly, the invention is not limited except as by the appended claims.

It is claimed:

1. A host system communicatively linked to remote computers of shoppers, the host system comprising:
at least one of a merchandise database configured to store information associated with merchandise for sale to the shoppers, and a services database configured to store information associated with services for sale to the shoppers;
a shopper data collector configured to collect and analyze data from the remote computers of shoppers to determine information usable to formulate tailored store screens for shoppers, including for a current communication with the host system by each shopper, data from the shopper's computer collected and analyzed during the current communication from which the shopper data collector determines for the current communication the location of the shopper's computer at the time of the current communication, without the host system requiring the shopper to take any direct action to instruct the shopper's computer to provide such information to the host system and without the host system having such information prior to the current communication;
a presentation formulator configured to formulate tailored store screens to be displayed on the remote computers of shoppers, including for the current communication by the shopper, formulating one or more tailored store screens to be displayed on the shopper's computer during the current communication, the one or more tailored store screens being formulated by the presentation formulator by including and excluding selected information in at least one of the merchandise database and the services database at least in part based upon the location of the shopper's computer at the time of the current communication, as determined by the shopper data collector; and
a web server configured to communicate with the remote computers of shoppers and to send the tailored store screens to the remote computers.

2. The host system of claim 1 wherein the data collected and analyzed by the shopper data collector from the shopper's computer during the current communication to determine information usable to formulate the one or more tailored store screens to be displayed on the shopper's computer during the current communication includes the search request the shopper entered into the shopper's computer to navigate to the host system to initiate the current communication, without the host system requiring the shopper to take any direct action to instruct the shopper's computer to provide such information to the host system and without the host system having such information prior to the current communication, and wherein the one or more tailored store screens to be displayed on the shopper's computer during the current communication are formulated by the presentation formulator by including and excluding selected information in at least one of the merchandise database and the services database at least in part based upon the search request the shopper entered into the shopper's computer to navigate to the host system to initiate the current communication, as determined by the shopper data collector.

3. The host system of claim 1 wherein the data collected and analyzed by the shopper data collector from the shopper's computer during the current communication to determine information usable to formulate the one or more tailored store screens to be displayed on the shopper's computer during the current communication includes the prior web site from which the shopper navigated to the host system to initiate the current communication, without the host system requiring the shopper to take any direct action to instruct the shopper's computer to provide such information to the host system and without the host system having such information prior to the current communication, and wherein the one or more tailored store screens to be displayed on the shopper's computer during the current communication are formulated by the presentation formulator by including and excluding selected information in at least one of the merchandise database and the services database at least in part based upon the prior web site from which the shopper navigated to the host system to initiate the current communication, as determined by the shopper data collector.

4. The host system of claim 1 wherein the data collected and analyzed by the shopper data collector from the shopper's computer during the current communication to determine information usable to formulate the one or more tailored store screens to be displayed on the shopper's computer during the current communication includes the software installed on the shopper's computer at the time of the current communication, without the host system requiring the shopper to take any direct action to instruct the shopper's computer to provide such information to the host system and without the host system having such information prior to the current communication, and wherein the one or more tailored store screens to be displayed on the shopper's computer during the current communication are formulated by the presentation formulator by including and excluding selected information in at least one of the merchandise database and the services database at least in part based upon the software installed on the shopper's computer at the time of the current communication, as determined by the shopper data collector.

5. The host system of claim 1 wherein the data collected and analyzed by the shopper data collector from the shopper's computer during the current communication to determine information usable to formulate the one or more tailored store screens to be displayed on the shopper's computer during the current communication includes the search request the shopper entered into the shopper's computer to navigate to the host system to initiate the current communication, the prior web site from which the shopper navigated to the host system to initiate the current communication and the software installed on the shopper's computer at the time of the current communication, without the host system requiring the shopper to take any direct action to instruct the shopper's computer to provide such information to the host system and without the host system having such information prior to the current communication, and wherein the one or more tailored store screens to be displayed on the shopper's computer during the current communication are formulated by the presentation formulator by including and excluding selected information in at least one of the merchandise database and the services database at least in part based upon the search request the shopper entered into the shopper's computer to navigate to the host system to initiate the current communication, the prior web site from which the shopper navigated to the host system to initiate the current communication and the software installed on the shopper's computer at the time of the current communication, as determined by the shopper data collector.

6. The host system of claim 1 wherein the location of the shopper's computer at the time of the current communication, as determined by the shopper data collector, is used by the shopper data collector to determine for the current communication particular traits, habits, or interests of the shopper or other pertinent shopper information, then used by the presentation formulator to formulate the one or more tailored store screens to be displayed on the shopper's computer during the current communication.

7. The host system of claim 1 wherein the presentation formulator formulates the one or more tailored store screens to be displayed on the shopper's computer during the current communication to contain at least one of a direct response advertisement area and an impulse advertisement area, containing information on at least one of merchandise and services related at least in part to the location of the shopper's computer at the time of the current communication, as determined by the shopper data collector.

8. The host system of claim 1 wherein the location of the shopper's computer at the time of the current communication, as determined by the shopper data collector, is stored on a publicly accessible database.

9. The host system of claim 8 wherein the publicly accessible database is the Domain Naming System entries of publicly accessible network delegation records.

10. A system to provide information regarding at least one of merchandise and services to each of a plurality of computers via at least one communication session through a network, each of the computers having a network address used to address each computer on the network, the system comprising:
a database configured to store information associated with at least one of merchandise and services;
a data collector configured to determine, from data transmitted from one of the computers to the system during a current communication session, the identity of the network address of the computer, the data collector further configured to determine, through use of the identity of the network address, additional information about the computer that is in addition to the identity of the computer's network address, without need of a communication session between the system and the computer occurring prior to the current communication session and without need of the computer furnishing any portion of the additional information about the computer to the system; and
a presentation formulator configured to select, based at least in part upon the additional information about the computer determined by the data collector, data regarding at least one of merchandise and services from the database to be included in at least one tailored screen to be displayed on the computer during the current communication session with the system.

11. The system of claim 10 wherein the data collector is configured to determine additional information about the computer by reading the additional information from a publicly accessible database.

12. The system of claim 11 wherein the data collector is configured to read the additional information from a publicly accessible database known as the Domain Name System (DNS).

13. The system of claim 10 wherein the data collector is configured to determine additional information about the computer by accessing publicly accessible information stored in a publicly accessible database using the identity of the network address.

14. The system of claim 13 wherein the data collector to configured to access a publicly accessible database known as the Domain Name System (DNS) database.

15. The system of claim 10 wherein data collector is configured to determine geographical location of the computer as the additional information about the computer.

16. The system of claim 10 comprising at least one web server configured to send the at least one tailored screen to the computer via the network during the current communication session.
